(19) United States
(12) Patent Application Publication
(10) Pub. No.: US 2014/0345146 A1
(43) Pub. Date: Nov. 27, 2014

(54) UTILITY KNIFE

(71) Applicant: Peter Schekalla, Wuppertal (DE)

(72) Inventor: Peter Schekalla, Wuppertal (DE)

(21) Appl. No.: 14/371,899

(22) PCT Filed: Jan. 28, 2013
(86) PCT No.: PCT/DE2013/000047

§ 371 Date: Jul. 11, 2014

(30) Foreign Application Priority Data
Jan. 27, 2012 (DE) 102012001490.2

(51) Int. Cl. B26B 3/00

(52) U.S. Cl. CPC B26B 3/00
USPC 30/169

(57) ABSTRACT

The invention relates to a cutting tool (10) having a handle (11) and at least one first blade (15) that comprises at least one cutting edge (13a, 13b). The special feature is that the cutting tool (10) additionally comprises at least one scraping edge (14) by means of which a scraping operation can be carried out.

The invention relates to a utility knife as set forth in the introductory clause of claim 1.

A utility knife of this type is disclosed in DE 20309701. The utility knife has a cutting edge that is accessible at a guide notch. The guide notch is sized so as to prevent a user from being injured by the cutting edge. A pulling motion enables the material being cut to be drawn into the guide notch and moved to the cutting edge. The utility knife is provided with a second tool in the form of a projecting element to sever materials that cannot be cut by the first tool.

The object of the invention is to create a utility knife that can be manufactured by simple and cost-effective means, and provides a wide range of applications.

The object is achieved according to the invention by a utility knife having the features of claim 1.

The utility knife comprises a handle and at least one first blade. The blade has at least one cutting edge. The edge is sufficiently sharp that it can cut a workpiece. The blade is mounted so as to be recessed into the interior of the utility knife relative to at least one outer surface of the utility knife. The knife has at least one cutting notch for guiding material to be cut to the cutting edge. The cutting edge delimits the notch on one side. The notch restricts access to the cutting edge. The cutting edge is inaccessible to the user if the cutting notch is of such a width for example as to prevent a finger from being able to move into the notch into contact with the cutting edge.

The cutting notch is created and restricted, for example by guide flanks of the blade holder and/or by guide flanks of the handle of the utility knife. For example, a first and a second cutting notch are provided on the utility knife. It is then possible to hold the utility knife in two positions in order to cut with it.

The cutting edge is oriented for example such that a cutting action can be effected by moving the utility knife in a first direction. The first direction for example is a pulling motion that extends toward the user.

The utility knife in addition has at least one scraping edge. The scraping edge, for example is dull. The user cannot is injure himself on the scraping edge. A layer can be scraped away from a face of a substrate by the scraping edge. For example, the scraping edge can be used to remove residual adhesive from a substrate. The scraping action can be effected for example by moving the utility knife in a second direction. The second direction is for example a pushing motion extending away from the user.

The blade as defined by the invention is a component that is provided with a cutting edge and/or with a scraping edge. Possible materials for the blade include, for example metal or ceramic. The blade can be composed, for example of strip steel. The thickness of the blade can measure for example between 0.2 mm and 0.7 mm, in particular, 0.3 mm.

The blade can include for example one or more holes that enable the blade to be fastened to a holder or to the handle. The holes allow the blade to be fastened to the blade holder for example by interlocking engagement. Plastic material flows through the holes for example when the blade is overmolded with plastic. This approach enables interlock to be created after the plastic has solidified by cooling.

One embodiment is characterized in that the scraping edge is also part of a blade. The scraping edge can thus be produced separately, then attached to the utility knife during assembly.

The utility knife can be produced, for example in that at least one blade is overmolded with plastic, thereby creating the blade holder and the handle. Alternatively for example at least one blade can be overmolded with plastic, thereby creating a blade holder. Following this, the blade holder can for example again be overmolded with plastic in order to create the handle. Alternatively, the blade holder can be attached to a plastic or metal handle by interlocking engagement or by gluing. The blade holder can for example be locked in place or glued to the handle. This allows the blade holder and the handle to be produced for example with different colors and materials.

Another embodiment is characterized in that the cutting edge and the scraping edge are part of the same blade. The utility knife can then be produced simply and cost effectively. The blade can be composed for example of a conventional strip-steel blade. At least one region of a sharpened edge can for example then be used as the cutting edge. For example, the blade can be mounted in the utility knife in such a way that two regions of the cutting edge are accessible for material to be cut and can be used for cutting. An unsharpened or dull edge of the same blade can be used for example as the scraper.

One embodiment is characterized in that the cutting edge and/or the scraping edge extend substantially perpendicular to a longitudinal axis of the utility knife. The cutting edge and/or the scraping edge form a right angle to the longitudinal axis of the utility knife. Alternatively, the cutting edge and/or the scraping edge can form an acute angle with the longitudinal axis of the utility knife. The cutting edge and/or the scraping edge in another alternative form an obtuse angle with the longitudinal axis of the utility knife. The longitudinal axis is formed for example by the central axis of the handle of the utility knife.

One embodiment of the invention is characterized in that the cutting edge and the scraping edge are parallel to each other.

For example, the cutting edge and the scraping edge face in opposite directions. If for example the cutting edge and the scraping edge are straight, they are each oriented in a direction perpendicular to the center line. For example, the working directions of the cutting edge and the scraping edge are oriented to face oppositely. It is possible for example to use a cutting edge of a blade as the cutting edge and an opposite for example parallel edge of a blade as the scraper. The cutting action can then be effected for example by moving the utility knife in a first direction, while the scraping action can be effected by moving the utility knife in a second direction. The first direction is opposite the second direction.

One embodiment is characterized in that at least one blade holder is provided for the blade. The blade holder can be provided for example so as to support the blade. The blade holder has for example at least one first wing that essentially supports the entire length of the blade. For example, the retaining arm has at least one second wing that supports at least one section of the blade in a direction perpendicular to the longitudinal extent of the blade. The second wing can be provided for example on an end edge of the blade. In addition, the blade holder can for example form the guide flanks of the notch. The guide flanks are for example on the first wing or the second wing.

Another embodiment of the invention is characterized in that at least one portion of the scraping edge is rounded and forms a scoring edge. Film strips, such as adhesive tape for example, can be separated with the scoring edge.

Additional advantages are revealed in an embodiment shown in the drawing:

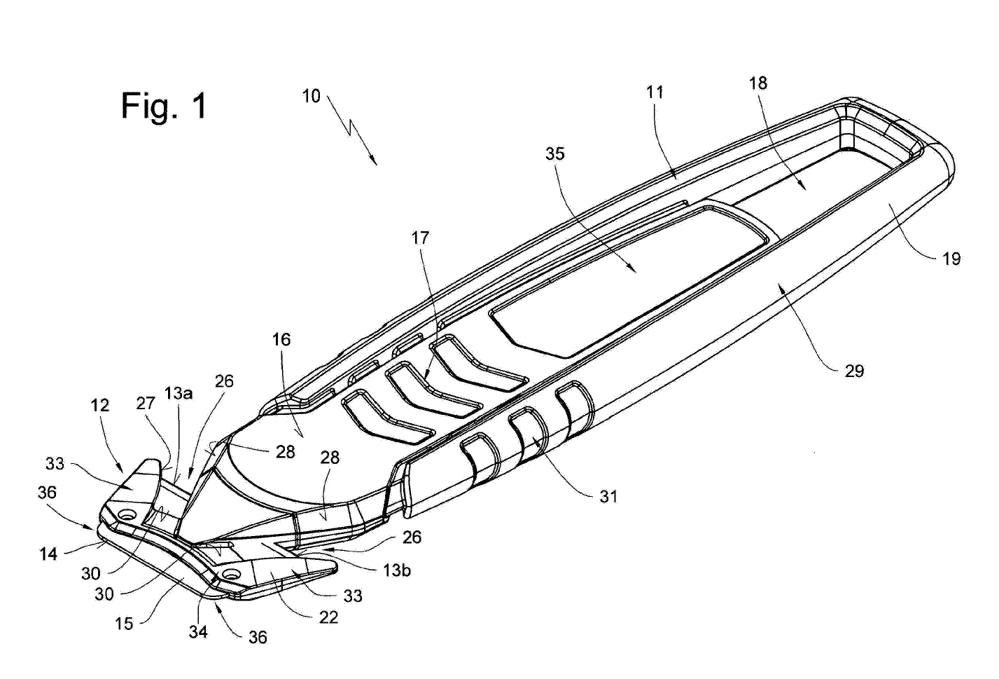

FIG. 1 is a schematic perspective view of the utility knife according to the invention;

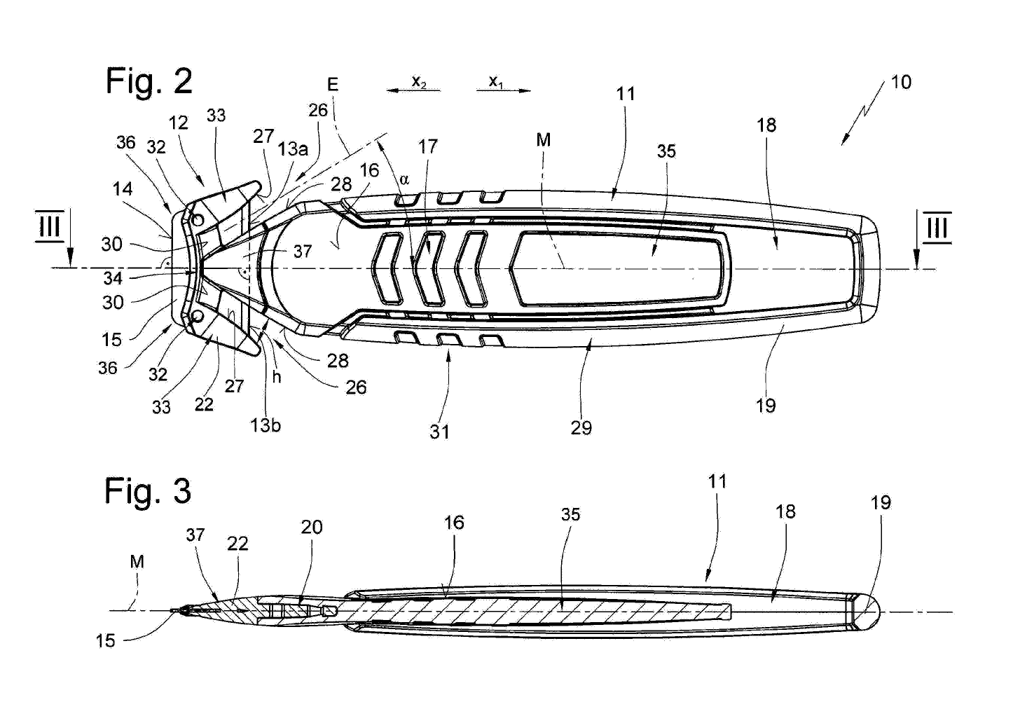

FIG. 2 is a schematic side view of the utility knife;

FIG. 3 is a sectional view along section line of FIG. 2;

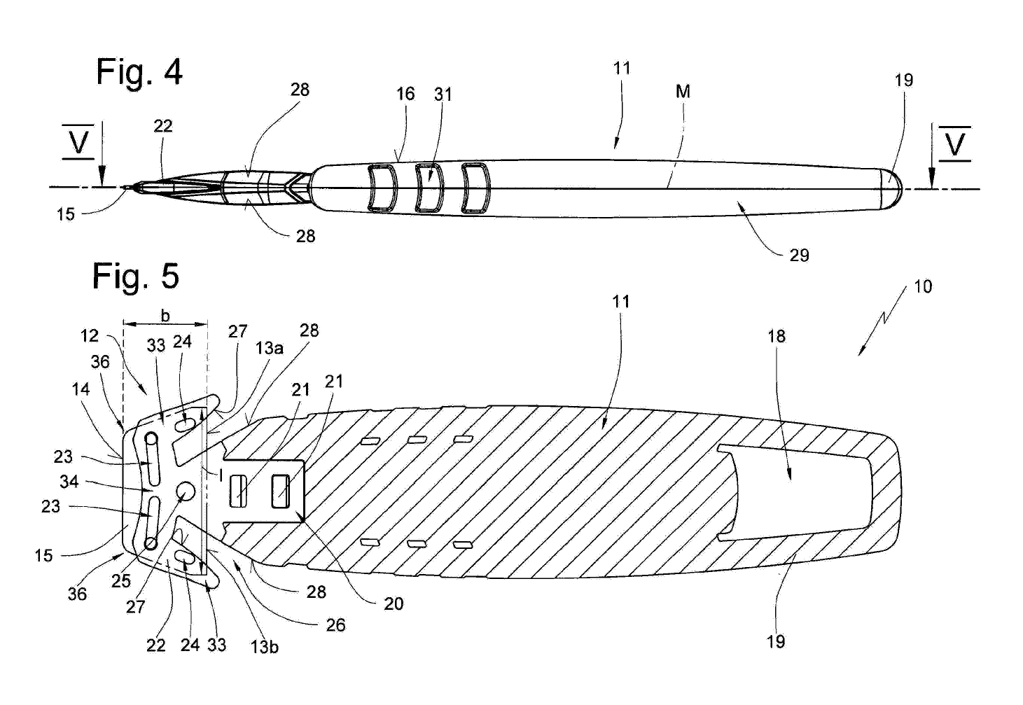

FIG. 4 is a schematic top view of the utility knife; and

FIG. 5 is a schematic sectional view along section line V-V in FIG. 4.

The utility knife is identified generally in the figures at 10. Identical reference characters in the various figures identify the same parts, including where lower-case letters have been added or omitted.

The utility knife 10 has a handle 11 and a blade holder 22 at one end 12 of the utility knife 10. A blade 15 is secured in the blade holder 22. The blade 15 has cutting edges 13a and 13b and a scraping edge 14. The cutting edges 13a and 13b are formed by a straight cutting edge of the strip-steel blade. The cutting edges 13a and 13b extend parallel to the scraping edge 14.

Each cutting edge 13a and 13b is accessible at a notch 26 that has guide flanks 27 and 28. The cutting edge 13a or 13b, and the guide flanks 27 and 28 define each notch 26. A central axis E of the notch defines an angle α relative to a central axis M. The angle α is for example an acute angle, in particular, one measuring approximately 45°. A width h of each notch 26 at a right angle to its central axis E is sized so as to prevent a user's finger from being able to move into the notch 26 to the cutting edge 13a or 13b.

The handle 11 has side faces 16. The top and bottom faces 16 are provided with ribs 17 that prevents the user's fingers from sliding off. Ribs are also provided on the narrow side edges 29. An opening 18 is provided in the handle 11 that enables the utility knife 10 to be hung for example on a hook. Most of the handle 11 is surrounded by a raised rim 19. The rim 19 surrounds a center section 35 of the handle 11 in an approximate C-shape. On a side facing away from central axis M, the rim 19 is provided with a convex arched shape so that the handle 11 can be effectively grasped in every holding position.

The blade holder 22 is made of plastic and has an extension 20 (see FIGS. 3 and 5) forming attachment structures that in this embodiment are cutouts 21. The blade holder furthermore has wings 33 and a connecting bight 34. The wings 33 support the blade 15 against deformation across a full blade width b. In addition, the wings 33 protect against undesirable contact with the blade 15 and form the guide flanks 27 of the notch 26. The connecting bight 34 supports the blade 15 against deformation across its length l. The connecting bight 34 furthermore forms inclined deflectors 30 that divert cut material away from the blade surface. The guide flank 28 is formed by a central region 37 of the blade holder 22, and an edge surface of the handle 11.

The blade holder 22 can be fastened to the handle 11 for example by overmolding the extension 20 of the blade holder 22 with plastic. The plastic of the handle 11 then surrounds extension 20 and extends through cutouts 21.

In an alternative to this embodiment, the blade holder 22 can also be secured for example to the handle 11, by interlocking engagement for example locked in place. The blade holder 22 and the handle 11 in this case include complementary fastening formations that can for example be attached to each other either releasably or permanently. The blade holder 22 and the handle 11 can for example be attached to each other by interlocking engagement or glued to each other.

The blade 15 has holes 23, 24, and 25. The holes 23, 24, and 25 function to allow attachment to blade holder 22. The holes 23, 24 and 25 are traversed by the plastic of the blade holder.

The purpose of the following discussion is to describe how the utility knife 10 is manufactured. The blade 15 is inserted into an unillustrated mold so as to allow form-stable pins to reach through the holes 23 while holding the blade 15 in place. The blade 15 is subsequently overmolded with plastic. The cooled and solidified plastic forms the blade holder 22. After demolding, holes 32 are formed at the location where the holding pins have passed through the blade 15. The blade holder 22 in turn is overmolded with plastic that is cooled and solidified to form the handle 11. Alternatively, the blade holder 22 can also be fastened to the handle 11 by interlocking engagement as described above.

The functional principle of the utility knife 10 is described below. In order to cut for example paper, sheet/film, or strips, the material to be cut is engaged into one of notches 26a or 26b by a pulling motion of utility knife 10, then cut with the cutting edge 13a or 13b. A pulling motion in this case means that the motion at least comprises a component oriented in a direction x₁ parallel to the central axis M of the utility knife 10.

In order to employ the utility knife 10 as a scraper, a pushing motion is applied to the utility knife 10. A pushing motion means that the motion at least comprises a component oriented in a direction x₂ parallel to the central axis M. The direction x₂ is opposite to the direction x₁.

The scraping edge 14 is rounded along side portions and creates scoring edges 36 that can be used to score for example adhesive tape or other films.

1. A utility knife comprising a handle and at least one first blade that has at least one cutting edge, wherein at least one cutting notch is provided on the utility knife at which material to be cut can be moved to the cutting edge, wherein the utility knife also has at least one scraping edge for scraping action.

2. The utility knife according to claim 1, wherein the scraping edge is part of a blade.

3. The utility knife according to claim 2, wherein the cutting edge and the scraping edge are on the same blade.

4. The utility knife according to claim 1, wherein the scraping edge is essentially perpendicular to a longitudinal central axis of the utility knife.

5. The utility knifes according to claim 1, wherein the cutting edge and the scraping edge are parallel to each other.

6. The utility knife according to claim 1, wherein the cutting edge and the scraping edge are directed in opposite directions.

7. The utility knife according to claim 1, wherein at least one blade holder is provided for the blade and is carried at one end of the utility knife.

8. The utility knife according to claim 1, wherein at least one portion of the scraping edge is rounded and creates a scoring edge.
